(19) United States
(12) Patent Application Publication
(10) Pub. No.: US 2012/0256724 A1
(43) Pub. Date: Oct. 11, 2012

(54) FOUR-WAY ELECTRONIC LOCK

(76) Inventors: Vehbi Dayanikli, Bursa (TR); Mustafa Dayanikli, Bursa (TR)

(21) Appl. No.: 13/518,558

(22) PCT Filed: Nov. 11, 2010
(86) PCT No.: PCT/TR2010/000218

§ 371 Date: Jun. 22, 2012

(30) Foreign Application Priority Data
Mar. 2, 2010 (TR) 2010/01561

(51) Int. Cl. G05B 19/00

(52) U.S. Cl. 340/5.54

(57) ABSTRACT

An electronic lock has at least one display screen and at least one micro engine locking system in order to ensure locking operation in electronic lock embodiments used in items such as an electronic door, drawer, locker, casing, cabinet, safe storage boxes, sections and other applications. At least one direction selective key and/or sensor is placed inside the lock which provides reading of said display screen by the user when it is connected in four different directions to the equipment in which it would be placed. A browsing and confirmation key group is provided, which do not comprise a number or an alphanumeric sign, in order to provide safe entry of the password by the user.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to an electronic lock, which is used in electronic door, drawer, locker, casing, cabinet, safe storage boxes, sections and etc. applications.

The invention particularly relates to the electronic lock, which can be mounted in 4-ways or positions, and which can be mounted on any of the lockers, doors, and drawers in the enterprise.

2. Description of Related Art Including Information Disclosed Under 37 CFR 1.97 and 37 CFR 1.98.

Nowadays, it is known that electronic lockers are used for providing high security locking systems. Especially, electronic lockers are more commonly used in steel casings and sections in which private documents are kept. It is a great problem for the users to carry or lose keys. While using casings with keys, users are afraid from the key being copied by another person or from losing the key or forgetting it somewhere. Therefore, development of electronic lockers in parallel with the present technology has gained great speed.

In the prior art, electronic locks are encountered which are provided with different methods. Electromagnetic bobbin (solenoid bobbin) is employed in commonly used electronic lockers. Electromagnets are used in another electronic locking system. Electronic locks commonly comprise a keypad by which password entered by the user, a display screen, an electronic card evaluating the password and ensuring controls, and locking mechanism for conducting the locking/unlocking operation after confirmation of the password. Moreover, the electronic locks can also be operated with RFID cards. Entry of password through keypad is a risky operation, since the password can be seen by others. Therefore, it is an expected requirement to develop different alternatives instead of keypad.

In the known status of the art, it is known that various applications are present related with the electronic locking systems. One of these applications is the Korean patent application with no KR20030019541. In said application, electronic lock systems in which security is ensured by entrance of password secretly or by remote control are described. The battery found on the locking system body is used as the power source. The locking component is inside the lock piece and thus provides locking Again, in the European patent with no EP1599651 B1, the electronic locking system comprising solenoid servo-mechanism is disclosed.

In the electronic locking systems becoming widespread in parallel with the development of technology, it is possible to increase the number of improvements made on locking mechanisms and the number of patent applications made as a result of these improvements. The patent with no. TR 2008 01927 and name “micro engine lock bolt system”, application of which is made by our company, can be given as an example to these improvements. All the present electronic locks are not available to be mounted on the equipment (locker, drawer, casing, door etc.) on which they would be used. In general, they are produced in different shapes and sizes for each type of equipment, which restricts the usage areas of the lockers and increases their costs. The prior electronic locks do not have the feature of being mountable in 4-directions/ways. In order to be able to mount an electronic lock in all 4-ways, its way of usage should be described to the producer and afterwards it is produced in that way, or in some locks, keypad part of only two directions would be removed and re-mounted in the other direction. These would cause loss of time, money, and energy . . .

Moreover, in the locks, password of which is entered through keypad, a nearby person seeing the password entered is of high possibility, which increases the security weakness.

The electronic locks used in the prior art are inadequate in solution of the problems such as security and availability. The above said improvements only eliminate some parts of the present drawbacks and an electronic lock mechanism, which would eliminate all of the drawbacks is not encountered in the prior art.

As a result, the need for an electronic lock, which can be fitted in 4-ways and positions, and which can be easily mounted, and the inadequacy of the present solutions have necessitated improvement in the related technical field.

### BRIEF SUMMARY OF THE INVENTION

The present invention relates to electronic lock mountable in four directions, which meets the above said requirements, eliminates all of the drawbacks and brings about some additional advantages.

The purpose of the invention is to provide an electronic lock, which can be easily mounted in 4-ways or positions.

The purpose of the invention is to provide mounting of the same lock both to the lockers, doors, and drawers of an enterprise by using different accessories.

Another purpose of the invention is to provide a more secure password entry facility to the users via the keying system it comprises.

Another purpose of the invention is to provide an electronic lock, which can be produced at smaller sizes because of its keying system.

Another purpose of the invention is to provide an electronic lock, which has fewer parts, can be mounted in more directions, has lower cost, is more secure, and consumes less battery.

Another purpose of the invention is to provide an electronic lock, which can be easily mounted since it has single-piece structure. Easy conduction of the mounting operation provides saving time and labour.

In order to achieve the above said purposes, the invention is the electronic lock having at least one display screen and at least one micro engine locking system in order to ensure locking operation in electronic lock embodiments used in electronic door, drawer, locker, casing, cabinet, safe storage boxes, sections and etc. applications, and it comprises at least one direction selective key and/or sensor placed inside the lock which provides reading of said display screen by the user when the lock is connected in four different directions to the equipment in which it would be placed, and browsing and confirmation key group, which do not comprise number or an alphanumeric sign, in order to provide entry of the password by the user.

In order to achieve the above said advantages which will be better understood from the below detailed description, the present invention; brings about many advantages through its said characteristics.

The structural and characteristic features of the invention and all advantages will be understood better in detailed descriptions with the figures given below and with reference to the figures, and therefore, the assessment should be made taking into account said figures and detailed explanations.

### BRIEF DESCRIPTION OF THE DRAWINGS

For better understanding of the embodiment of present invention and its advantages with its additional components, it should be evaluated together with below described figures.

FIG. 1 is the demounted view of the four-way electronic lock, which is the subject of the invention.

FIG. 2 is the front view of a sample application of the four-way electronic lock, which is the subject of the invention.

FIG. 3a is the front view of the application of the four-way electronic lock, which is the subject of the invention, intended for vertical usage.

FIG. 3b is the front view of the application of the four-way electronic lock, which is the subject of the invention, intended for reverse-vertical usage.

FIG. 3c is the front view of the application of the four-way electronic lock, which is the subject of the invention, intended for horizontal usage.

FIG. 3d is the front view of the application of the four-way electronic lock, which is the subject of the invention, intended for reverse-horizontal usage.

### REFERENCE NUMBERS AND ABBREVIATIONS

1. Main Body

2. PCB Electronic Circuit

3. Display Lower Piece

4. Display Screen

5. Browsing and Confirmation Key Group

6. Mini USB Connector

7. Mini USB Cover

8. 4-Way Selective Key

9. Handle Bearing Piece

10. Brass Contact

11. Handle

12. AAA Battery

13. Optic Reflection Sensor

14. Handle Bearing Plastic

15. Rotating Bolt Connection Piece

16. Micro Engine Locking System

17. Rear Cover with Battery Housing

18. Ball Item (3 mm)

19. Rotating Lock Bolt

20. Handle Contact Spring

21. Brass Mounting Nut

22. Right-Left Selective Metal Sheet Piece

PCB (Printed Circuit Board)

USB (Universal Serial Bus)

LED (Light Emitting Diode)

OLED (Organic Light Emitting Diode)

LCD (Liquid Crystal Display)

### DETAILED DESCRIPTION OF THE INVENTION

In this detailed description, the preferred embodiments of the four-way electronic lock, which is the subject of the invention, will only be disclosed for better understanding of the subject, and will not form any limiting effect. The door, drawer, locker, casing and etc. embodiments, in which the electronic lock of the invention would be placed, will be referred as equipment in herein below descriptions.

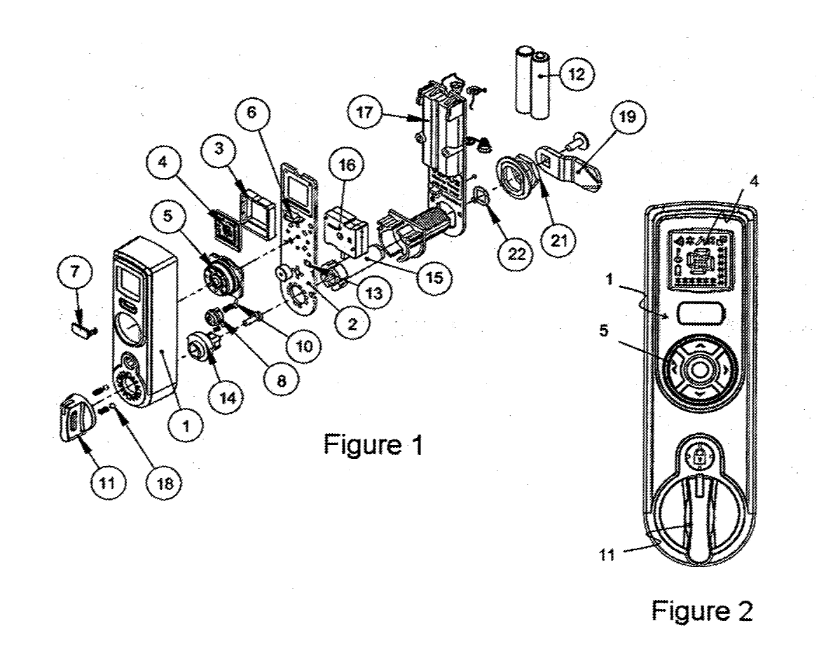

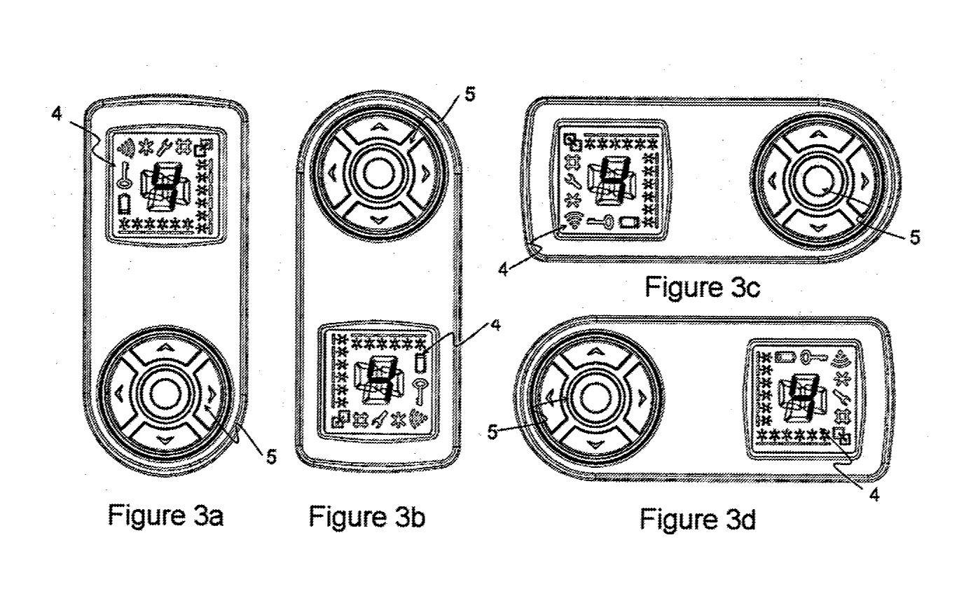

In FIG. 1, the demounted view of the four-way electronic lock, which is the subject of the invention, is given. Electronic lock can be connected in 4 different directions on the equipment, on which it would be placed. Applications in different directions are shown in FIGS. 3a, 3b, 3c, and 3d. While it can be connected in vertical direction, it can also be connected in reverse-vertical direction. While it can be connected in horizontal direction in right-to-left plane, it can also be connected in reverse-horizontal direction. The electronic lock can be mounted in four directions since said display screen (4) can be seen straight in 4 different directions via at least one direction selective key (8) positioned inside the lock. In case of mounting of the electronic lock in vertical direction, password entry is ensured via at least one browsing and confirmation key group (5), which is seen at the lower part of said display screen (4). Different from the normal keypads, high security password entry is only ensured via browsing and confirmation key group (5). The keys do not include a number or an alphanumeric sign. They only comprise right, left, up, and down keys and a confirmation key at the centre. When the user wants to enter password, he determines the number he desires using the up-down keys and when he reaches the desired number he presses the confirmation key. The electronic lock confirms entrance of the numbers through sound and some symbols—preferably star symbol-found on the display screen (4). In this way, the user can enter numbers of four or more digits in accordance with the password pre-determined by him. If the password entered by the user via the browsing and confirmation key group (5) is the same with the pre-loaded password, the lock pulls the bolt and lets the user turn and open the handle (11). If the password is entered wrong by the user, again a vocal warning is given and “E” (error) sign lights on the screen (4).

Password can be entered in 2 different ways to the electronic lock, which is the subject of the invention.

In the first method; the password and lock management information can be entered by choosing numbers or letters via four browsing keys and one confirmation (5) keys on the screen (4), which can be read straight in four directions. In the second method; the password information can be introduced to the lock via the RFID (Radio Frequency Identification) card through the antenna formed at the lower part in front of the lock.

In the preferred applications of the invention, said display screen (4) can be LED, LCD, or OLED regarding different advantages (cost) of usage.

In similar preferred embodiments of the invention, positioning of the lock is determined via the selective key (8) or sensor. Via the selective key (8), direction sensor, or lock position determined from the program menu, said display screen (4) is electronically re-organized in a way that it would be read straight.

The protection area of this application has been specified under claims and cannot be limited to the descriptions only given as sampling above. It is obvious that a person skilled in the related art can apply the innovation disclosed by this invention into similar purposed other areas by means of changing the parts in form and using similar structures. Therefore, it is also clear that such embodiments lack of innovation criteria and especially the criteria of exceeding the known status of the art.

1. An electronic lock having at least one display screen and at least one micro engine locking system in order to ensure locking operation in electronic lock embodiments used in electronic door, drawer, locker, casing, cabinet, safe storage boxes, sections and etc. applications, and it is characterized in that; it comprises at least one direction selective key and/or sensor placed inside the lock which provides reading of said display screen by the user when the lock is connected in four different directions to the equipment in which it would be placed, and browsing and confirmation key group, which do not comprise number or an alphanumeric sign, in order to provide entry of the password by the user.

2. An electronic lock according to claim 1, characterized in that; said browsing and confirmation key group comprises; right, left, up, and down keys and a confirmation key at the center.

3. An electronic lock according to claim 1, characterized in that; it comprises the browsing and confirmation key group, functions of which are changed electronically when the lock is connected in four different directions.

4. An electronic lock according to claim 1, characterized in that; the user determines the number that he desires by using the up-down keys inside the browsing and confirmation key group when he wants to enter password, enters the password having more than one numbers/letters by pressing the confirmation key when he reaches the number he desires, and the micro engine locking system opens if the entered password is the same with the pre-loaded password.

5. An electronic lock according to claim 1, characterized in that; said display screen is electronically programmed in a manner that it could be read straight, via the selective key, direction sensor or the lock position determined from the program menu.

6. An electronic lock according to claim 1, characterized in that; said display screen can be LED, LCD, or OLED.
